(19) United States
(12) Patent Application Publication
(10) Pub. No.: US 2006/0191176 A1
(43) Pub. Date: Aug. 31, 2006

(54) Image to video device

(76) Inventor: Donald F. Sobetsky, Lansdale, PA (US)

Correspondence Address: Frank A. Mazzeo;Frank A. Mazzeo, P.C., Suite 200, 808 Bethlehem Pike, Colmar, PA, 18915, US

(21) Appl. No.: 11/344,614

(22) Filed: Feb. 1, 2006

Related U.S. Application Data
(60) Provisional application No. 60/657,647, filed on Feb. 28, 2005.

(51) Int. Cl. G09F 9/37

(52) U.S. Cl. 40/446

(57) ABSTRACT

A device for storing and displaying at least one still image, wherein the at least one still image can convert to a video display. A method for presenting a still image and then converting the still image to display a video.

### CROSS REFERENCE TO RELATED APPLICATION

This application claims priority from U.S. Provisional Application No. 60/657,647, filed on Feb. 28, 2005, which is incorporated herein by reference as if fully set forth.

### BRIEF DESCRIPTION OF DRAWINGS

FIG. 1A depicts an embodiment of the invention in still image status.

FIG. 1B shows the embodiment of FIG. 1A after the still image has been transformed into a video.

### DESCRIPTION

The Image to Video Device (Device) displays at least one image in normal mode. The image can be in any form, including the following: picture, painting or photograph. In one step, e.g., press of a button, remote control or motion detector, the image transforms into a video. The video may include audio. The video may relate to the still image.

A person skilled in the art would be able to construct the Device using already existing technology for image display devices, video display devices, motion detector devices, etc.

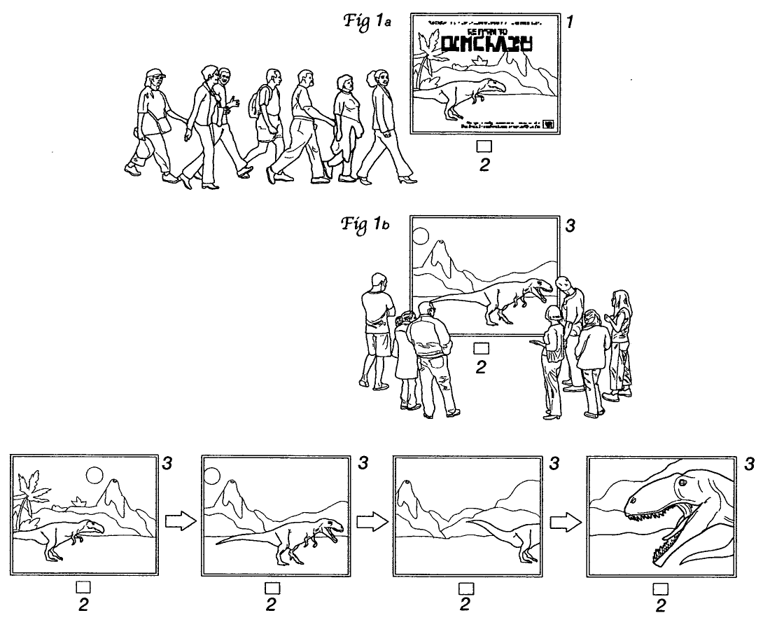

In one preferred embodiment, the Device can be incorporated into an advertisement display. In such embodiment, the Device could be a store sign or billboard. In one example, shown in FIGS. 1A and 1B, the advertisement could be used to promote an upcoming movie and the image 1 could be that of a character in the movie. If powered by a motion detector 2, the still image 1 of the character could transform into a video 3 of the character when a viewer approaches the advertisement display and activates the motion detector 2. The video 3 could include sound.

In one preferred embodiment, at the completion of the video, the Device again displays the still image.

In another preferred embodiment, the Device can display as a picture frame or poster. In such embodiment, the Device can be hung on a wall or placed on furniture, e.g., desk. In such embodiments, the Device can be in various sizes and styles.

In another preferred embodiment, the Device can be incorporated into a photo frame. In one example, the Device can display a still image of the family dog. At the push of a button, the image of the dog transforms into a video of the dog running, with barking and other sounds included.

In one embodiment, the Device can be a postcard suitable for carrying around in one's pocket, purse or wallet.

In preferred embodiments, the Device is powered by electricity, including by battery.

Embodiments also could incorporate and/or be used with memory devices such as memory stick technology and/or memory cards. For example, the Device could have the capability to contain and read a memory stick or memory cards. In such embodiments, the memory devices can be used to change or supplement the images and videos to be displayed in the Device.

The Device also could be capable of storing more than one video and/or image memory at a time. In such embodiments, the still image displayed in normal mode can change each time the video mode is played. For example, in the family dog embodiment described above, a different still image of the dog can be displayed after the video is played.

Embodiments also could incorporate and/or be used with LCD technology. Also, the Device can be connected to the Internet via a USB connection or other means.

What is claimed is:

1. A device for storing and displaying at least one still image, wherein the at least one still image can convert to a video display.

2. The device of claim 1, wherein the device is at least one of the following: picture frame, poster, painting and advertising sign.

3. The device of claim 1, wherein the device converts from still image mode to video mode by at least one of the following steps: push of a button, remote control and motion detector.

4. The device of claim 1, wherein audio is included.

5. The device of claim 1, wherein the device converts from still image mode to video mode and then back to still image mode.

6. The device of claim 1, wherein the device converts from still image mode to video mode and then to still image mode, wherein the second still image is a different still image than the original still image.

7. The device of claim 1, wherein the video and still image are of the same subject matter.

8. A method for storing and displaying both still and video images comprising:
(a) providing at least one still image;
(b) converting the at least one still image to a video.

9. The method of claim 7 wherein the conversion of the still image to a video is done by at least one of the following steps: push of a button, remote control and motion detector activation.
